(19) United States
(12) Patent Application Publication
(10) Pub. No.: US 2009/0164562 A1
(43) Pub. Date: Jun. 25, 2009

(54) CONTENTS RECORDING AND REPRODUCING APPARATUS

(75) Inventor: Katsutoshi Inagaki, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Tokyo (JP)

(21) Appl. No.: 12/096,686

(22) PCT Filed: Mar. 30, 2007
(86) PCT No.: PCT/JP2007/057131

§ 371 Date: Jun. 9, 2008

(30) Foreign Application Priority Data
Mar. 31, 2006 (JP) 2006-099589

(51) Int. Cl. G06F 15/16

(52) U.S. Cl. 709/203

(57) ABSTRACT

An apparatus which enables the user to obtain desired contents through a network in real-time manner is provided. The contents recording and reproducing apparatus provides client's desired contents through a network, wherein a contents list to be provided to the client is always updated according to a present state of an operating state of at least one of its own software resource or hardware resource.

### TECHNICAL FIELD

The invention relates to a contents recording and reproducing apparatus and, more particularly, to a contents recording and reproducing apparatus for providing stored contents to a client connected to a network.

### BACKGROUND ART

Techniques have been provided in which various kinds of apparatuses such as personal computers, peripheral devices, and AV apparatuses are allowed to provide services mutually on a network. As one of the techniques, Universal Plug and Play (hereinbelow, referred to as UPnP (registered trademark)) of Microsoft Corporation is known.

According to the UPnP technique of non-Patent Document 1: http://www.upnp.org/, an apparatus (device) and a control apparatus (control point) connected by the network mutually make recognition and exchange XML (eXtensible Markup Language) documents in which URL (Uniform Resource Locators) showing locations of a service and the like have been disclosed, so that the device can provide the service and the control point can control the device.

For example, in a contents recording and reproducing apparatus (device) for recording and/or reproducing contents, first, the contents recording and reproducing apparatus automatically obtains an IP address by an addressing function of UPnP. A client (control point) recognizes the contents recording and reproducing apparatus as a device which can be controlled by himself by a discovery function. The client further obtains detailed information regarding the contents recording and reproducing apparatus, contents information held in the contents recording and reproducing apparatus, and the like by a description function. A URL as an address of the contents is included in the contents information. When there is a change in the contents information or the like of the contents recording and reproducing apparatus, by an eventing function as a state monitoring function, the client receives an event notification which is issued to the client by the contents recording and reproducing apparatus.

Ordinarily, a control unit of the contents recording and reproducing apparatus monitors a contents storing unit. When one of the changes described below occurs with respect to the held contents information, the control unit forms a contents list again and issues an event. That is,
a case where contents has been added into the contents storing unit;
a case where the contents has been deleted from the contents storing unit; and
a case where there is a change in meta information (attribute information) of the contents.

The event is transmitted only to the client whose event issuance has been registered in the contents recording and reproducing apparatus. The client who received the event requests the contents recording and reproducing apparatus and obtains the contents list updated by using the description function.

### DISCLOSURE OF INVENTION

### Problem to be Solved by the Invention

There is, however, a case where an execution of dubbing or the like takes place in the contents recording and reproducing apparatus in a period of time during which the client obtains the contents list from the contents recording and reproducing apparatus and actually executes a reproduction. In such a case, since the contents recording and reproducing apparatus uses resources of hardware and/or software for the purpose of dubbing, there can be a case where the apparatus enters a state where the resources to provide the contents to the client are insufficient and the contents cannot be provided although the contents exists on the contents list. With reference to a user interface (UI) on a display or the like, the user who requested the provision of the contents looks at an error indication occurring when the client has transmitted a reproducing request to the contents recording and reproducing apparatus, so that he knows for the first time that the contents recording and reproducing apparatus is in the state where it cannot provide the contents onto the network. In other words, there is such a problem that despite the display of the contents list indicating that the contents can be obtained, the client is unable to obtain the desired contents and it is necessary to execute the operations to request the selection and reproduction once again.

The invention has been made to solve the problems described above and it is an object of the invention to provide an apparatus which enables the user to obtain reproducible contents in real-time and can reduce the unwell feeling of the user.

### Means for Solving the Problem

According to the invention, there is provided a contents recording and reproducing apparatus comprising: storing and reproducing means for storing and/or reproducing contents; and control means for controlling a transmission of a contents list of the contents and an event based on contents information to a client through a network, wherein the apparatus further comprises monitoring functioning means for obtaining resource information indicating an operating state of at least one of a software resource and a hardware resource of the storing and reproducing means and the control means, and the control means issues an event based on a change in contents of the resource information and updates the contents list based on present contents of the resource information.

### ADVANTAGES OF THE INVENTION

As mentioned above, according to the invention, the resources in the contents recording and reproducing apparatus are monitored and used as targets of the event issuance and contents is formed again by using the event as a trigger, so that the client can obtain the latest contents information in real-time. If the eventing function as an inevitable installed function in the UPnP standard is used, on the client apparatus's side, an additional construction is unnecessary and burdens of an increase in the number of functions to be installed and an increase in costs are not caused. In the contents recording and reproducing apparatus in which the monitoring function has been installed, it is sufficient that the eventing function has been installed in the client apparatus.

### BRIEF DESCRIPTION OF DRAWINGS

FIG. 1 is a block diagram showing a construction of a contents recording and reproducing apparatus according to an embodiment of the invention and a client apparatus connected thereto.

### MODE FOR CARRYING OUT THE INVENTION

An embodiment of the invention will be described hereinbelow with reference to the drawing.

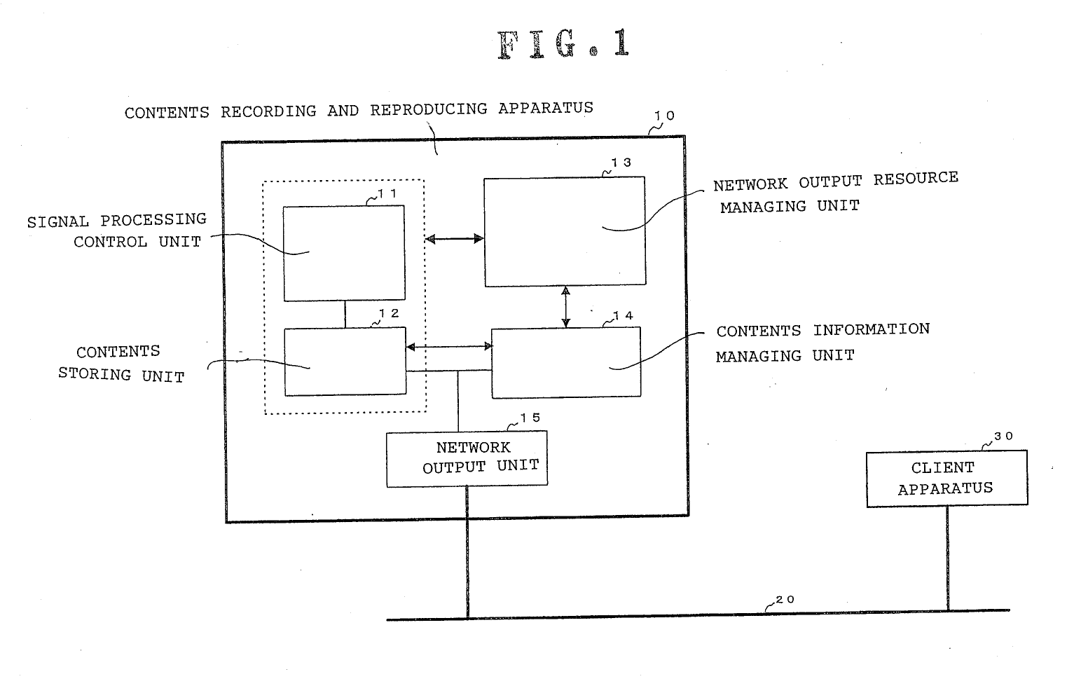

FIG. 1 is a block diagram showing a construction of a contents recording and reproducing apparatus 10 according to the embodiment of the invention and a client apparatus connected thereto. The contents recording and reproducing apparatus 10 according to the embodiment can communicate with a client apparatus 30 through a network 20. The contents recording and reproducing apparatus 10 may be any of contents storing/reproducing apparatuses which can hold contents into its own storing means or an annexed SD memory card or the like and provide the contents onto the network. An AV apparatus such as a DVD, a personal computer, and the like are incorporated. As a client apparatus, various apparatuses which can be connected to the network can be used and a personal computer, a monitor, a cellular phone, and the like may be used. Further, a case where the contents held by the client as the contents recording and reproducing apparatus is provided to another client is also taken into account. The network may be either a wired network or a wireless network.

The contents recording and reproducing apparatus 10 according to the embodiment comprises a signal processing control unit 11, a contents storing unit 12, a network output resource managing unit 13, a contents information managing unit 14, and a network output unit 15 which are mutually connected by an internal bus. The signal processing control unit 11 and the contents storing unit 12 together constitute storing and reproducing means. The signal processing control unit 11 allows the contents to be stored into the contents storing unit 12 serving as storing means of the contents and/or allows the contents to be reproduced from the contents storing unit 12. In cooperation with the contents storing unit 12 and the like, the signal processing control unit 11 executes a signal process for recording and reproducing the contents, operation control of input/output units, and the like. For example, the signal processing control unit 11 is a control unit of a DVD recorder and includes a buffer, a coder, a decoder, input/output terminals, a D/A converter, a microcomputer, a data transfer bus (not shown), and the like. The network output resource managing unit 13 is monitoring functioning means of resource information for managing software and/or hardware resources which are necessary for transmitting the contents in the contents recording and reproducing apparatus 10 to the network. The contents information managing unit 14 is control means for providing the contents information to the client apparatus 30, issuing various kinds of events, and executing a transmission and a reception. The network output unit 15 is an interface for transmitting the contents to the network.

Subsequently, the operation of the contents recording and reproducing apparatus 10 according to the embodiment will be described.

The contents recording and reproducing apparatus 10 and the client apparatus 30 transmit and receive the contents information by the discovery function, the description function, and the like. The contents information managing unit 14 has a function for opening the contents held in the contents storing unit 12, as a contents list, to the client apparatus 30 which has performed the discovery in the network. If there are an addition/deletion of contents and a change in contents meta information, the contents information managing unit 14 forms a contents list again, further issues an event “SystemUpdateID”, and notifies the client apparatus 30 of the event. The operations mentioned above are similar to those described in the related art. The network output resource managing unit 13 also always monitors the hardware resource and the software resource in the contents recording and reproducing apparatus 10 and manages a using situation of the resources and the permission or inhibition about their usability. The network output resource managing unit 13 has such a function that each time the using situation of the resources changes, it communicates with the contents information managing unit 14 and can calculate an amount and kinds of resources which are necessary to transmit the open contents to the network and whether or not they can be transmitted. For example, although the following reasons or the like can be mentioned as using reasons of the resources regarding the permission or inhibition about the output, the invention is not limited to them.
The target contents is being used due to the dubbing.
A contents format cannot be converted because an LSI resource is being used.
An output resource of HD contents is insufficient because an internal bus is occupied.
The target contents is being used by another client.

If the contents which cannot be transmitted exists as a result of the calculation based on the using situation of the resources, the network output resource managing unit 13 notifies the contents information managing unit 14 of it. When the notification is received, the contents information managing unit 14 forms a contents list again. In a manner similar to the case of the addition or the like of contents, the contents information managing unit 14 issues a SystemUpdateID event and notifies the client 30 of it. When the event notification is received, the client 30 detects that there is a change in the contents list which has already been obtained, and obtains the contents list again by the description function.

In the embodiment, the reason why the client has received the SystemUpdateID event is that the contents information has been changed due to a use restriction of the hardware resource in the contents recording and reproducing apparatus 10. Although the reasons for generation of the event is not important for the client, the client obtains the contents list by using the notification of the event as a trigger. The contents which can be actually reproduced, therefore, can be obtained in a real-time manner.

Subsequently, an embodiment 2 in the case of issuing a ContainerUpdateIDs event in addition to the SystemUpdateID event will be described. In all of the following embodiments, a construction of the contents recording and reproducing apparatus 10 is the same as that in the embodiment 1.

Although the installation of the SystemUpdateID event is indispensable as the so called an eventing function in the UPnP technique, ContainerUpdateIDs can be also installed as an option. In the foregoing embodiment 1, after the contents list was formed again in the contents information managing unit 14, ContainerUpdateIDs may be issued in addition to SystemUpdateID. Although SystemUpdateID is a notification regarding the change for the whole contents delivery service (CDS), ContainerUpdateIDs is a change notification which is made on a container unit basis.

The container denotes a play list, a directory, or the like. For example, in the case where the contents recording and reproducing apparatus 10 has the following directory construction and the third file (file 4) is added to a directory 2, the contents information managing unit 14 issues ContainerUpdateIDs in which information indicating that there is a change in the directory 2 has been described.
directory 1 - - +- - directory 2 - - - +- - file 1
   +- - file 2
   +- - directory 3
   +- - directory 4 - - +- - file 3

At this time, SystemUpdateID is also simultaneously issued. If the client 30 received only SystemUpdateID as in the case of the embodiment 1, only a fact that there is a change in the contents recording and reproducing apparatus 10 can be known. If ContainerUpdateIDs was also received, since the directory in which the change has occurred can be also known, an intelligent function can be realized. Specifically speaking, it is possible to omit such processes that when a file list of the directory 2 is displayed on a display screen, the contents list is obtained again, the display screen is updated in a real-time manner, and in other cases (for example, the case where a file list of the directory 4 is displayed on the display screen), it is determined that there is no need to update, and the contents list is obtained again. It is, therefore, unnecessary to execute wasteful processes. That is, in the contents recording and reproducing apparatus 10, by making it possible to cope with the ContainerUpdateIDs event, a further another client apparatus can be set to a target of the function according to the invention.

Subsequently, an embodiment 3 in the case of deleting only URL information with respect to the contents whose network output cannot be performed will be described.

The embodiments 1 and 2 relate to the method whereby the contents which cannot be transmitted due to the lack of resources is deleted from the list. In the embodiment 3, the contents is not deleted from the contents list but only partial information is deleted. For example, a URL is considered as information to be deleted. In the case of reproducing the contents, the client 30 designates the URL based on the contents information obtained by the description function to the contents recording and reproducing apparatus 10 in order to receive services. When the URL does not exist, the URL cannot be designated and the client 30 cannot request the contents recording and reproducing apparatus 10 to transmit the contents. When the contents list is displayed to the UI, the client 30 may display the contents in which the URL does not exist by a gray indication. In other words, the contents which cannot be transmitted in the contents recording and reproducing apparatus 10 is displayed in gray on the client side, the contents which is not displayed in gray can be identified as contents which can be transmitted. At the point of time, since the transmission-impossible contents can be also known by the gray indication, it is convenient for the user.

Subsequently, although an embodiment 4 is similar to the embodiment 1, after SystemUpdateID has been issued, a new contents list is formed in the embodiment. Actually, any one of the issuance of SystemUpdateID and the forming of the new contents list may be executed first. Although SystemUpdateID is issued after the updating contents list has been formed in the embodiment 1, the new contents list can be formed after SystemUpdateID has been issued first. By executing the issuance of SystemUpdateID first, the client can be more rapidly notified of the event information and the real-time performance is further improved.

In an embodiment 5, after SystemUpdateID has been issued and the client has been notified of it, when the user requests the obtainment of the contents list in accordance with the display by the UI or the like, on the client side, the resource information is confirmed and, thereafter, the forming of the updating contents list is started. In other words, for example, in addition to the obtainment of the resource information at a predetermined period, when there is an obtaining request from the client, the latest resource information is certainly obtained again. Although a response return speed of an offer of the contents list to the client becomes slow slightly, even in the case where a time is necessary until the user decides which contents should be reproduced, that is, until the user instructs the reproduction after the contents list has been displayed, the latest contents list can be provided.

Although the embodiments are based on the specification of UPnP, naturally, the invention is not limited to the specification. That is, the contents recording and reproducing apparatus according to the invention updates the contents list according to the present state of the operating state of its own resource.

1. A contents recording and reproducing apparatus comprising: storing and reproducing means for storing and/or reproducing contents; and control means for controlling a transmission of a contents list of said contents and an event based on contents information to a client through a network, wherein
said apparatus further comprises monitoring functioning means for obtaining resource information indicating an operating state of at least one of a software resource and a hardware resource of said storing and reproducing means and said control means, and
said control means issues an event based on a change in contents of said resource information and updates said contents list based on present contents of said resource information.

2. A contents recording and reproducing apparatus according to claim 1, wherein said contents includes an address showing its own existing position and said control unit transmits the contents information in which the address of the contents corresponding to the contents of said resource information has been disclosed or deleted to said client.

3. A contents recording and reproducing apparatus according to claim 1, wherein said control unit confirms the present contents of said resource information when there is an obtaining request from said client.
